(19) United States
(12) Patent Application Publication
(10) Pub. No.: US 2014/0220828 A1
(43) Pub. Date: Aug. 7, 2014

(54) SIGNAL CONNECTOR MODULE

(71) Applicant: RICH ELECTRIC WIRE AND CABLE CO. LTD., Yunlin (TW)

(72) Inventor: Chang-Chi Lee, Yunlin (TW)

(73) Assignee: RICH ELECTRIC WIRE AND CABLE CO. LTD., Yunlin (TW)

(21) Appl. No.: 13/773,808

(22) Filed: Feb. 22, 2013

(30) Foreign Application Priority Data
Feb. 6, 2013 (CN) 201310048075.2

(51) Int. Cl. H01R 13/60

(52) U.S. Cl. CPC H01R 13/60
USPC 439/638

(57) ABSTRACT

A signal connector module including a housing, a first connector, a second connector, and a first positioning member. The first connector is received in the chamber of the housing and is able to be moved out of the housing. The second connector is electrically connected to the first connector, and is moved between a first position, in which the second connector is received in chamber of the housing, and a second position, in which the second connector is moved out of the housing. The first positioning member is provided on the second connector to hold the second connector at the first position or at the second position.

The current application claims a foreign priority to the patent application of China No. 201310048075.2 filed on Feb. 6, 2013.

### BACKGROUND OF THE INVENTION

1. Field of the Invention

The present invention relates generally to a connector, and more particularly to a signal connector module.

2. Description of the Related Art

In the present market, there are a variety of connectors on various electronic devices, and Universal Serial Bus (USB) is the most common connector. However, there are several types of USB connectors, including Type-A, Type-B, mini USB, and micro USB. Some manufacturers even developed their own type of USB connector. As a result, it needs a specified USB cable for the connection of two electronic devices with different types of connectors.

The conventional USB cable has a cable and two connectors at opposite ends of the cable. The connectors respectively engage two electronic devices, such as computer and mobile phone, for transmission of signals and power. In present days, we have a lot of USB cables stored in a box in a mess. Furthermore, the connectors of the USB cable may be damaged accidently.

### SUMMARY OF THE INVENTION

The primary objective of the present invention is to provide a signal connector module, which is convenient for storage and provides a protection of the connectors.

According to the objective of the present invention, a signal connector module including a housing, a first connector, a second connector, and a first positioning member. The housing has a chamber therein, a first opening, a second opening, and a first bore. The first opening, the second opening, and the first bore are communicated with the chamber. The housing further has a first locking portion and a second locking portion. The first connector is received in the chamber of the housing and is able to be moved out of the housing through the first opening. The second connector is electrically connected to the first connector. The second connector is moved between a first position, in which the second connector is received in chamber of the housing, and a second position, in which the second connector is moved out of the housing through the second opening. The first positioning member, which is provided on the second connector, has a first controlling portion and a first engaging portion. The first controlling portion is received in the first bore of the housing and is able to move in the first bore to be operated by a user to move the second connector between the first position and the second position. The first engaging portion engages the first locking portion when the second connector is moved to the first position, and the first engaging portion engages the second locking portion when the second connector is moved to the second position.

Therefore, the signal connector module of the present invention may be operated and stored in an easy way.

### BRIEF DESCRIPTION OF THE DRAWINGS

FIG. 1 is a perspective view of a first preferred embodiment of the present invention;

FIG. 2 is another perspective view of the first preferred embodiment of the present invention;

FIG. 3 is an exploded view of the first preferred embodiment of the present invention;

FIG. 4A, FIG. 4B, and FIG. 4C are sectional views in the A-A′ line of FIG. 1, showing how the second connector is moved out;

FIG. 5 is a perspective view of a second preferred embodiment of the present invention;

FIG. 6 is another perspective view of the second preferred embodiment of the present invention;

FIG. 7 is an exploded view of the second preferred embodiment of the present invention;

FIG. 8A and FIG. 8B are sectional views in the B-B′ line of FIG. 5, showing how the second connector is moved out;

FIG. 9A and FIG. 9B are sectional views in the C-C′ line of FIG. 5, showing how the third connector is moved out;

FIG. 10 is a sectional view of the second preferred embodiment of the present invention, showing both the second connector and the third connector in the housing;

FIG. 11 is a sectional view of the second preferred embodiment of the present invention, showing the second connector being moved out of the housing; and

FIG. 12 is a sectional view of the second preferred embodiment of the present invention, showing the third connector being moved out of the housing.

### DETAILED DESCRIPTION OF THE INVENTION

The detailed description and technical contents of the present invention will be explained with reference to the accompanying drawings. However, the drawings are illustrative only but not used to limit the present invention.

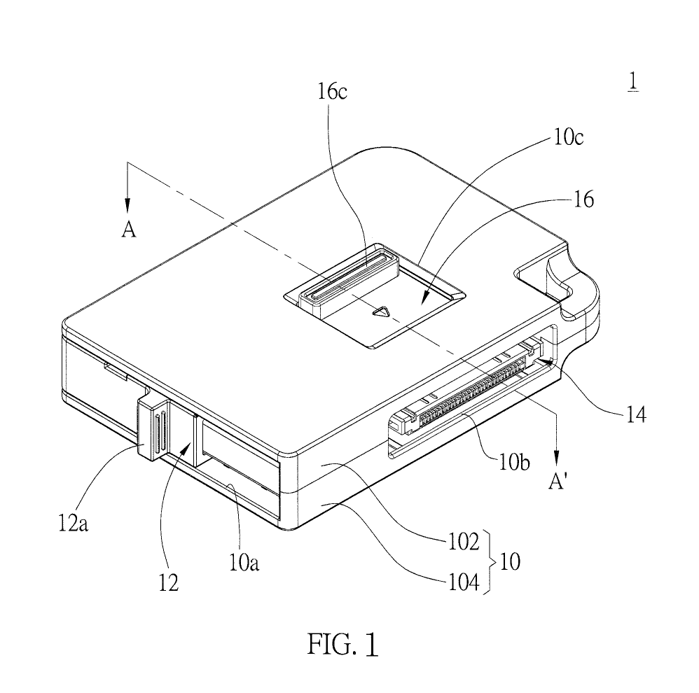

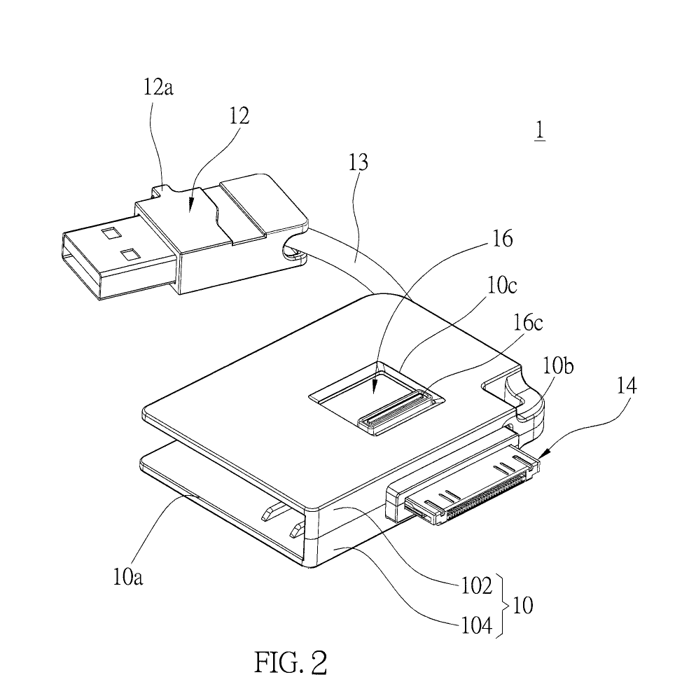

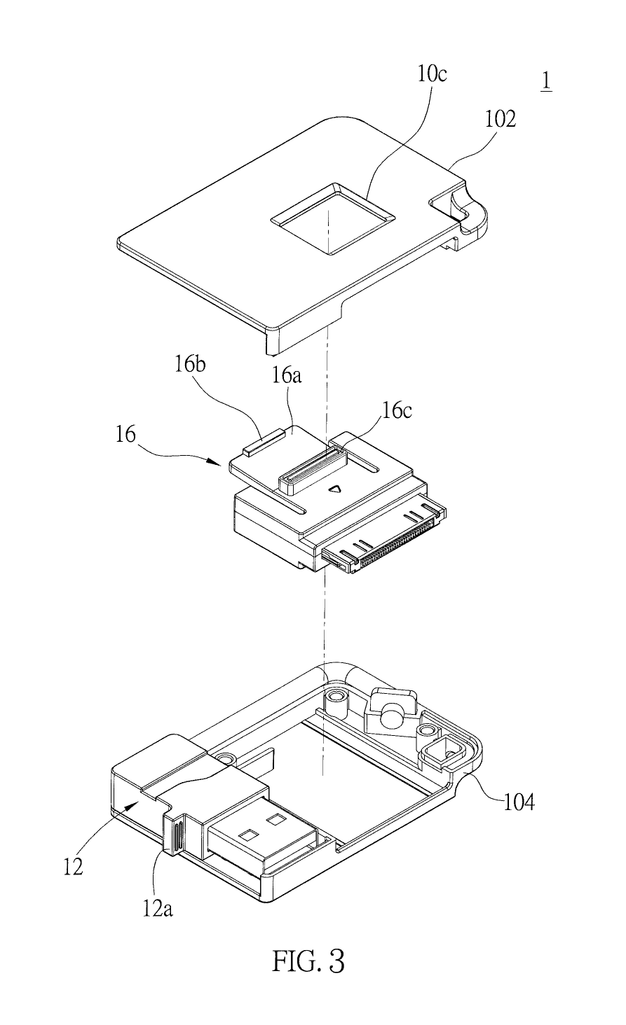

As shown in FIGS. from FIG. 1 to FIG. 4C, a signal connector module 1 of the first preferred embodiment of the present invention includes a housing 10, a first connector 12, a second connector 14, and a first positioning member 16.

The housing 10 is a rectangular hollow member, having a top case 102 and a bottom case 104 in connection to obtain a chamber therebetween. The housing 10 has a first opening 10a, a second opening 10b, and a first bore 10c, all of which are communicated with the chamber in the housing 10. The first opening 10a and the second opening 10b are on a peripheral side of the housing 10, and the first bore 10c are on the top case 102 (a top of the housing 10). The top case 102 has two recesses 10d, 10e on an inner side thereof. A predetermined distance is between the recesses 10d, 10e. The recess 10d forms a first locking portion, and the other recess 10e forms a second locking portion.

A wire 13 is connected to the first connector 12 so that the first connector 12 may be received in the housing 10 or moved out of the housing 10 through the first opening 10a. The first connector 12 has a protrusion 12a for a user to move the first connector 12.

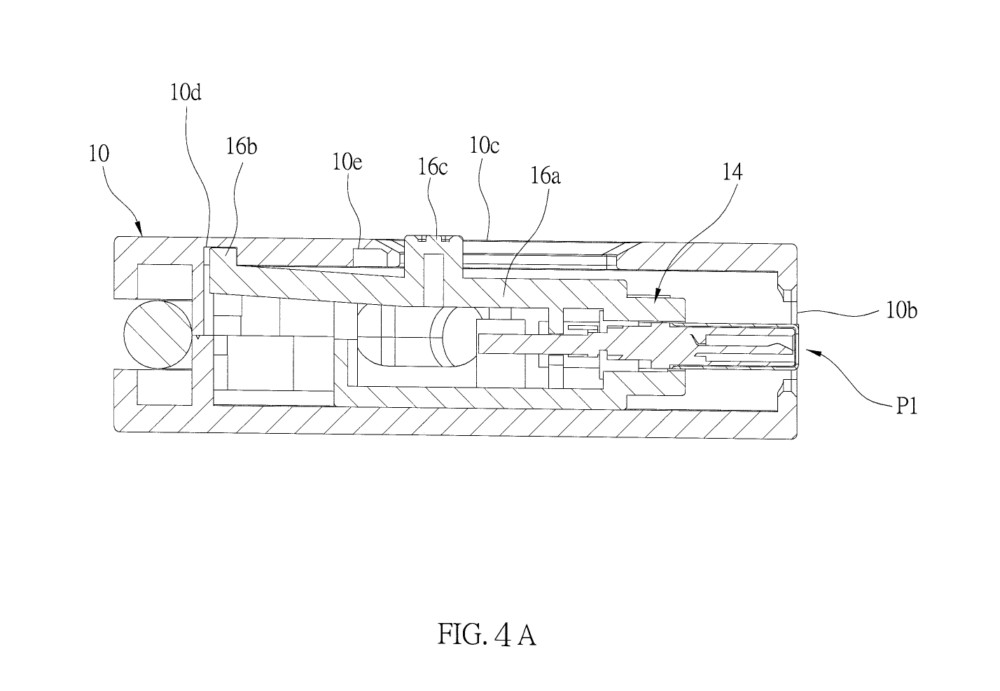

The second connector 14 is electrically connected to the first connector 12. The second connector 14 and the first connector 12 are different types of connectors. The second connector 14 is slidably mounted in the housing 10 to be moved between a first position P1 (FIG. 4A) and a second position P2 (FIG. 4C). The second connector 14 is received in the housing 10 when it is at the first position P1, and is moved out of the housing 10 via the second opening 10b when it is moved to the second position P2.

The first positioning member 16 is provided on the second connector 14. In an embodiment, the first positioning member 16 has a first flexible plate 16a, a protrusion 16b, and a first block 16c. The first flexible plate 16a has an end connected to the second connector 14 and the other end suspended. The protrusion 16b is on the suspended end of the first flexible plate 16a. The protrusion 16b fits the recesses 10d, 10e. The first block 16c is on a top side of the first flexible plate 16a and is in the first bore 10c of the housing 10. A user may press the first block 16c to move the second connector 14 to make the protrusion 16b engage the recess 10d or the recess 10e. In an embodiment, the first block 16c form a first controlling portion for a user to move the second connector 14, and the protrusion 16b forms a first engaging portion to engage the first locking portion or the second locking portion.

As shown in FIG. 4A, FIG. 4B, and FIG. 4C, the first block 16c is moved in the first bore 10c. While the first block 16c is moved to an end of the first bore 10c, which is distal to the second opening 10b, the second connector 14 is moved to the first position P1 and is totally received in the housing 10. At this time, the protrusion 16b engages the recess 10d (FIG. 4A) to hold the second connector 14 at the first position P1. As shown in FIG. 4B, while the user presses the first block 16c, the protrusion 16b disengages the recess 10d, and the user is able to move the first block 16c to the other end of the first bore 10c, which is proximal to the second opening 10b. Now, the second connector 14 is moved out of the housing 10 through the second opening 10b (to the second position P2). While the first block 16c is moved to a predetermined position, the protrusion 16b engages the recess 10e (FIG. 4C) to hold the second connector 14 at the second position P2. At this time, the second connector 14 is able to engage a connector of an electronic device. On the contrary, the user may press the first block 16c to disengage the protrusion 16b with the recess 10e, and now, the first block 16c may be moved back to receive the second connector 14 in the housing 10.

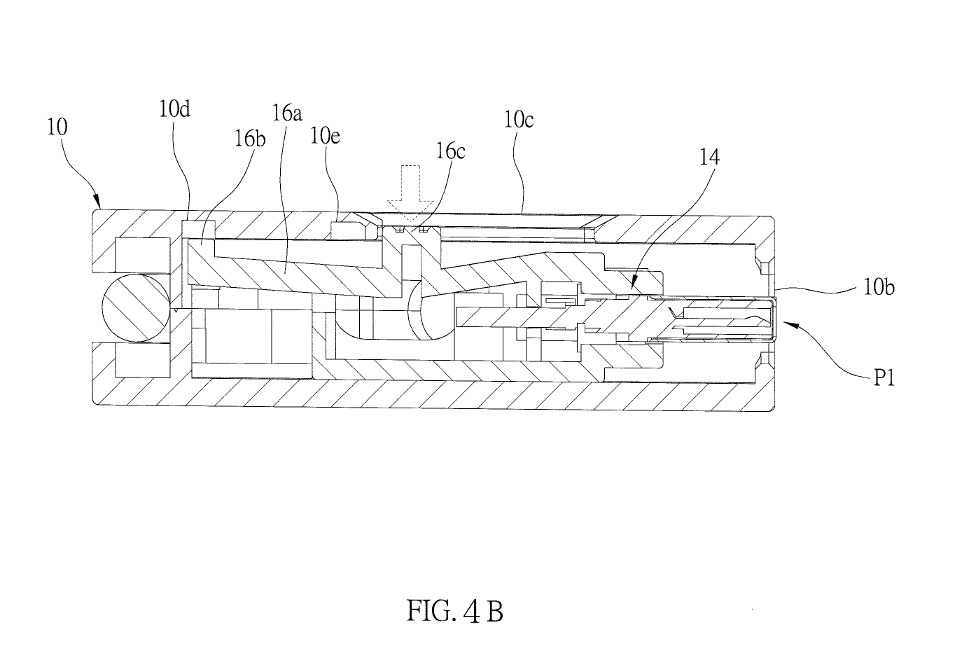

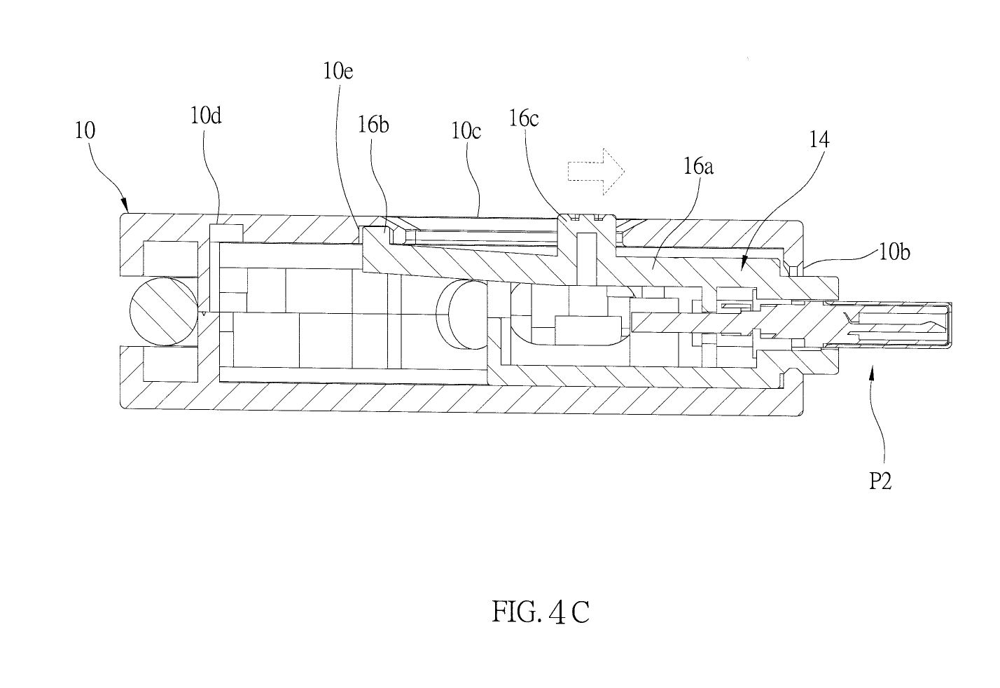

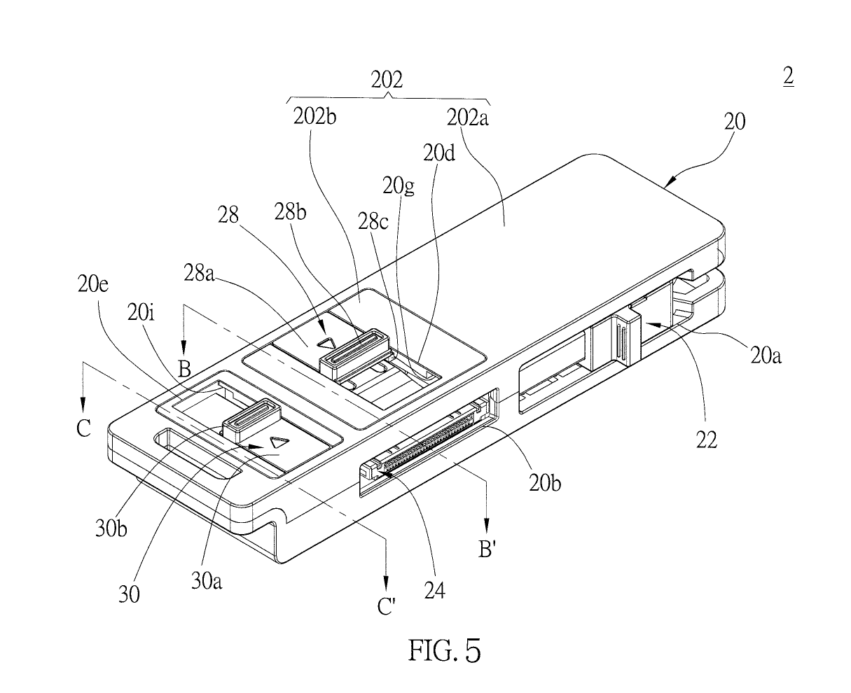

FIGS. from FIG. 5 to FIG. 12 show a signal connector module 2 of the second preferred embodiment, which includes a housing 20, a first connector 22, a second connector 24, a third connector 26, a first positioning member 28, and a second positioning member 30.

The housing 20 has a first opening 20a, a second opening 20b, a third opening 20c, a first bore 20d, and a second bore 20e. The second opening 20b and the third opening 20c are at opposite sides of the housing 20. The housing 20 has a top case 202, and the top case 202 has a top plate 202a and a pressing plate 202b. The first bore 20d and the second bore 20e are on the pressing plate 202b.

The pressing plate 202b has two recesses 20f on an inner side thereof, and the recesses 20f are at opposite sides of the first bore 20d. The recesses 20f form a first locking portion. The pressing plate 202b further has two recesses 20g on the inner side thereof to form a second locking portion. There is a predetermined distance between the recesses 20f and the recesses 20g. The pressing plate 202b further has two recesses 20h on the inner side thereof, and the recesses 20h are at opposite sides of the second bore 20e. The recesses 20h form a third locking portion. The pressing plate 202b further has two recesses 20i on the inner side thereof to form a fourth locking portion. There is a predetermined distance between the recesses 20h and the recesses 20i.

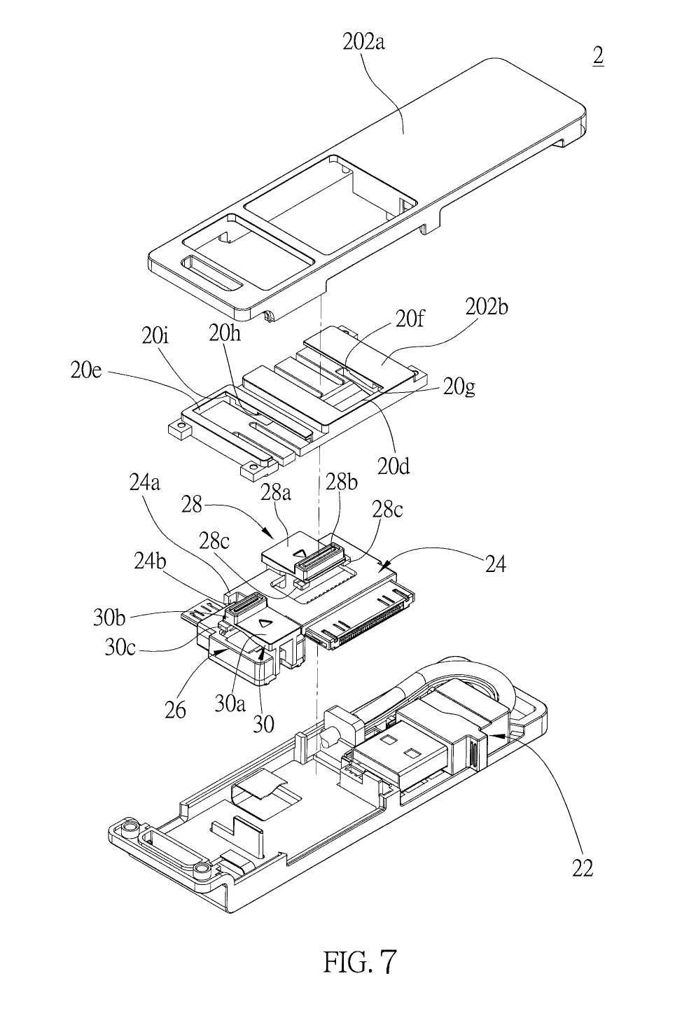

A wire is connected to the first connector 22 so that the first connector 22 may be received in the housing 20 or moved out of the housing 10 through the first opening 20a. The first, the second, and the third connectors 22, 24, 26 are three different types of connectors, and the second and the third connectors 24, 26 are electrically connected to the first connector 22 respectively. The second connector 24, which is the same as above, is received in the housing 20 or is moved out of the housing 10 through the second opening 20b. The third connector 26 is slidably mounted in the housing 20 to be moved between a third position P3 (FIG. 9A), in which the third connector 26 is received in the housing 20, and a fourth position P4 (FIG. 9B), in which the third connector 26 is moved out of the housing 10 through the third opening 20c.

The first positioning member 28 includes a first flexible plate 28a, a first block 28b, and two protrusions 28c. An end of the first flexible plate 28a is fixed to the third connector 26, and the other end thereof is suspended. The first block 28b and the protrusions 28c are on the first flexible plate 28a. The first block 28b is adjacent to the suspended end of the first flexible plate 28a, and the protrusions 28c are on opposite sides of the first block 28b. The first block 28b is in the first bore 20d. The second positioning member 30 includes a second flexible plate 30a, a second block 30b, and two protrusions 30c. An end of the second flexible plate 30a is fixed to the second connector 24, and the other end thereof is suspended. The second block 30b and the protrusions 30c are on the second flexible plate 30a. The second block 30b is adjacent to the suspended end of the second flexible plate 30a, and the protrusions 30c are on opposite sides of the second block 30b. The second block 30b is in the second bore 20e and is able to move in the second bore 20e. The second block 30b forms a second controlling portion, and the protrusions 30c form a second engaging portion.

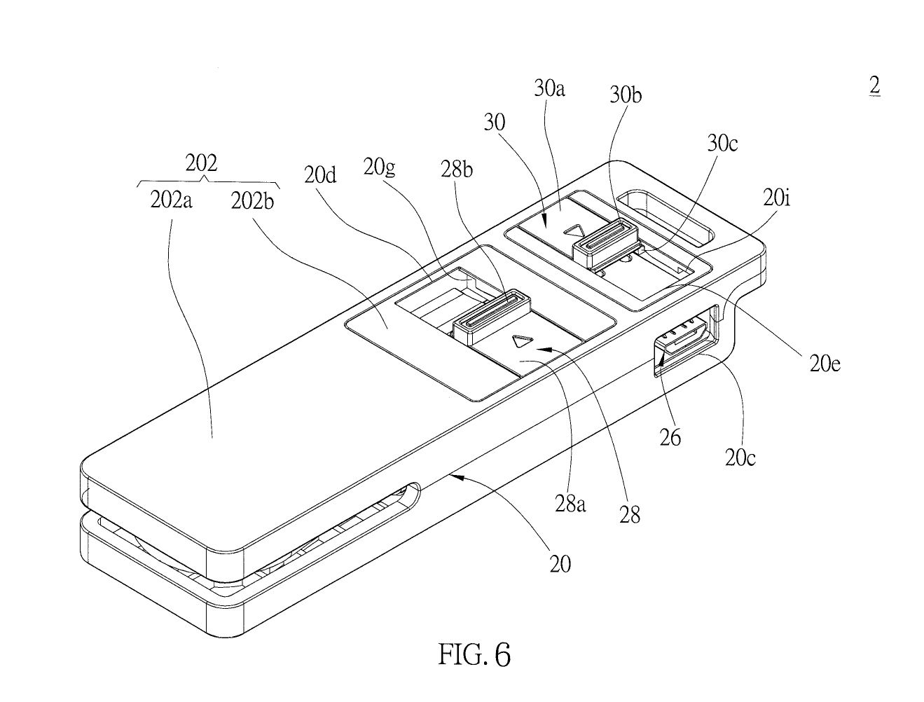

The user may press the first block 28b of the first positioning member 28 to move the second connector 24 between a first position P1 (FIG. 8A), in which the second connector 24 is received in the housing 20, and a second position P2 (FIG. 8B), in which the second connector 24 is moved out of the housing 20 through the second opening 20b.

As shown in FIG. 9A and FIG. 9B, the user may press the second block 30b of the second positioning member 30 to move the third connector 26 between a third position P3 (FIG. 9A) and a fourth position P4 (FIG. 9B). At the third position P3, the third connector 26 is received in the housing 20, and the protrusions 30 engage the recesses 20h. At the fourth position P4, the third connector 26 is moved out of the housing 20 through the third opening 20c, and the protrusions 30 engage the recesses 20i.

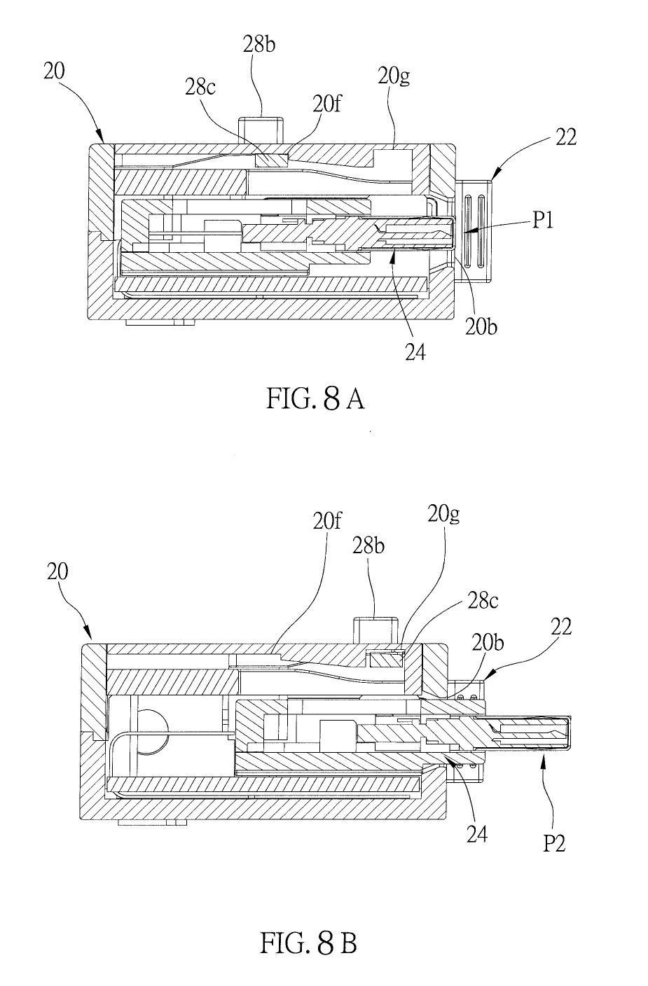

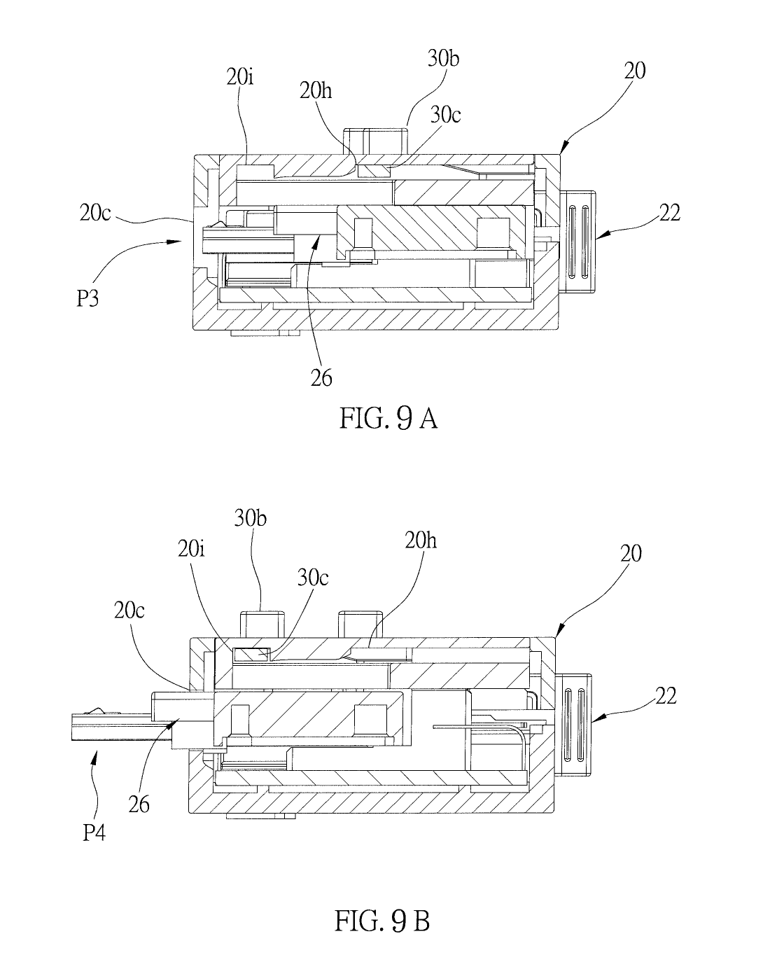

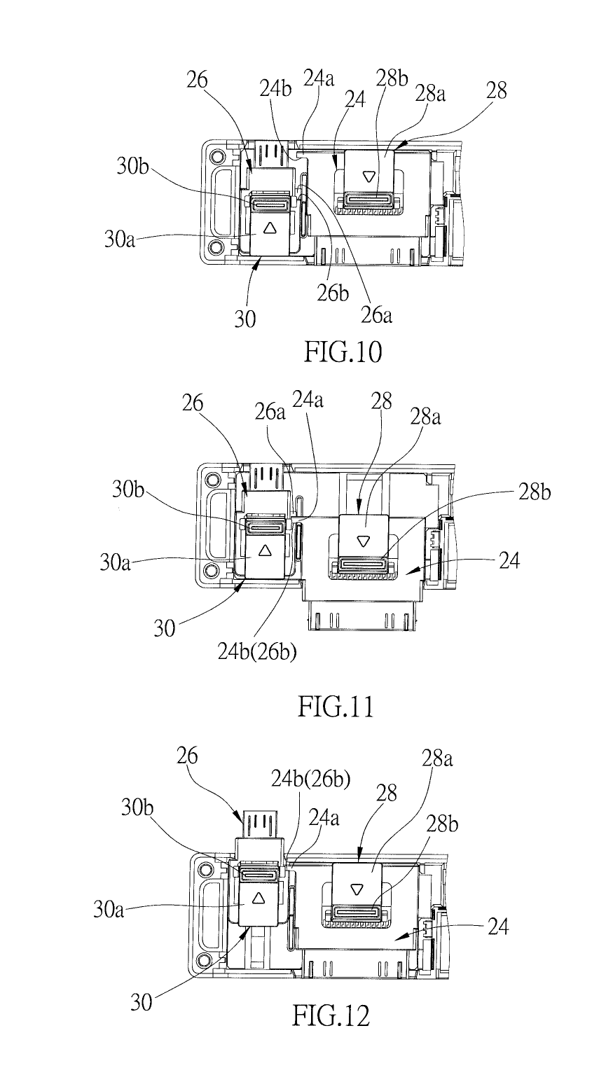

In an embodiment, the second connector 24 has a stop block 24a, and the third connector 26 has a recess 26a. The stop block 24a is in association with the recess 26a. The stop block 24a has a first stop face 24b, and a second stop face 26b is formed on a sidewall of the recess 26a. The first stop face 24b faces the second stop face 26b. While both the second connector 24 and the third connector 26 are received in the housing 20, the first stop face 24b is kept a distance away from the second stop face 26b (FIG. 10). While the user is moving the second connector 24 out of the housing 20, the first stop face 24b is moved toward the second stop face 26b, and while the second connector 24 is moved to the first position P1, the first stop face 24b touches the second stop face 26b. As a result, the third connector 26 is unable to be moved (FIG. 11). On the contrary, while the second connector 24 is received in the housing 20 and the third connector 26 is moved out of the housing 20, the second stop face 26b touches the first stop face 24b to make the second connector 24 stay in the housing 20 (FIG. 12). The function of it is that only one of the second connector 24 and the third connector 26 may be moved out of the housing 20, or both of them are received in the housing 20.

In conclusion, the signal connector module of the present invention provides a variety of plugs and sockets for connection, and they van be operated and stored in an easy way. Furthermore, it also provides that only one connector can be pulled out for connection at the same time. The description above is only a few preferred embodiments of the present invention and the equivalence of the present invention is still in the scope of claim construction of the present invention.

What is claimed is:

1. A signal connector module, comprising:
a housing having a chamber therein, a first opening, a second opening, and a first bore, wherein the first opening, the second opening, and the first bore are communicated with the chamber, and the housing further has a first locking portion and a second locking portion;
a first connector, which is received in the chamber of the housing and is able to be moved out of the housing through the first opening;
a second connector, which is electrically connected to the first connector, wherein the second connector is moved between a first position, in which the second connector is received in chamber of the housing, and a second position, in which the second connector is moved out of the housing through the second opening; and
a first positioning member, which is provided on the second connector, having a first controlling portion and a first engaging portion, wherein the first controlling portion is received in the first bore of the housing and is able to move in the first bore to be operated by a user to move the second connector between the first position and the second position; the first engaging portion engages the first locking portion when the second connector is moved to the first position, and the first engaging portion engages the second locking portion when the second connector is moved to the second position.

2. The signal connector module as defined in claim 1, wherein the first positioning member has a first flexible plate; an end of the first flexible plate is connected to the second connector, and an opposite end thereof is suspended, and the first controlling portion and the first engaging portion are provided on the first flexible plate.

3. The signal connector module as defined in claim 2, wherein the first locking portion has at least one recess on the housing; the second locking portion has at least one recess on the housing, and the first engaging portion has at least one protrusion to engage the recess of the first locking portion when the second connector is moved to the first position and to engage the recess of the second locking portion when the second connector is moved to the second position.

4. The signal connector module as defined in claim 1, further comprising a third connector and a second positioning member, wherein the housing further includes a third opening, a third bore, a third locking portion, and a fourth locking portion; the third connector is electrically connected to the first connector; the third connector is moved between a third position, in which the third connector is received in the chamber of the housing, and a fourth position, in which the third connector is moved out of the housing through the third opening; the second positioning member is provided on the third connector and has a second controlling portion and a second engaging portion; the second controlling portion is received in the second bore of the housing and is able to move in the second bore to be operated by a user to move the third connector between the third position and the fourth position; the second engaging portion engages the third locking portion when the third connector is moved to the third position, and the second engaging portion engages the fourth locking portion when the third connector is moved to the fourth position.

5. The signal connector module as defined in claim 4, wherein the second positioning member has a second flexible plate; an end of the second flexible plate is connected to the second connector and an opposite end thereof is suspended; and the second controlling portion and the second engaging portion are provided on the second flexible plate.

6. The signal connector module as defined in claim 5, wherein the third locking portion has at least one recess on the housing; the fourth locking portion has at least one recess on the housing, and the second engaging portion has at least one protrusion to engage the recess of the third locking portion when the third connector is moved to the third position and to engage the recess of the fourth locking portion when the third connector is moved to the fourth position.

7. The signal connector module as defined in claim 6, wherein the second connector has a first stop face, and the third connector has a second stop face; the first stop face is kept a predetermined distance away from the second stop face when both the second connector and the third connector are received in the chamber of the housing; the first stop face is moved toward the second stop face and touches the second stop face when the third connector is at the third position and the second connector is moved from the first position to the second position, whereby the second connector is moved out of the housing, and the third connector is held in the chamber of the housing; the second stop face is moved toward the first stop face and touches the first stop face when the second connector is at the first position, and the third connector is moved from the third position to the fourth position, whereby the third connector is moved out of the housing, and the second connector is held in the chamber of the housing.

8. The signal connector module as defined in claim 7, wherein the second connector has stop block, on which the first stop face is provided, and the third connector has a recess, on a sidewall of which the second stop face is provided.
